(19) United States
(12) Patent Application Publication
(10) Pub. No.: US 2009/0231316 A1
(43) Pub. Date: Sep. 17, 2009

(54) ROLLABLE BI-STABLE DISPLAY

(75) Inventor: Murray F. Gillies, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,045

(22) PCT Filed: Dec. 1, 2005
(86) PCT No.: PCT/IB05/54006

§ 371 Date: Jun. 7, 2007

(30) Foreign Application Priority Data
Dec. 9, 2004 (EP) 04106429.6

(51) Int. Cl. G09G 5/00; G09F 9/37

(52) U.S. Cl. 345/211; 40/446; 345/107; 345/87

(57) ABSTRACT

A system comprises a rollable sheet (SH) forming a loop. The rollable sheet has a first section (SH1) forming a first optically addressable bi-stable display and a second section (SH2) forming a second optically addressable bi-stable display, the first section (SH1) and the second section (SH2) are electrically isolated. A rotating unit rotates (SP1, SP2, M1) said sheet (SH), wherein in a first position (P1), the first section (SH1) is viewable while the second section (SH2) is hidden, and in a second position (P2), the second section (SH2) is viewable while the first section (SH1) is hidden. A changing unit (VG1, VG2, AD, CO) changes a first image on the first section (SH1) while displaying a second image on the second section (SH2) when in the second position (P2), and for changing the second image of the second section (SH2) while displaying the first image on the first section (SH1) when in the first position (P1).

The invention relates to a system comprising a rollable sheet with bi-stable displays, a billboard comprising this system, the use of the rollable sheet forming a loop in a billboard, and to a method of displaying an image in a system comprising the rollable bi-stable display.

US2003/0011868 discloses a card which includes a photoconductive layer and an electrophoretic layer. The impedance of the photoconductive layer is lowered when stuck by light from the light emitting layer. Where the impedance of the photoconductive layer is lower, the electrophoretic layer may be addressed by an applied electrical field to update an image on the card. In an embodiment, the light emitting layer is open from the rear, and is addressed via direct drive or active matrix drive schemes. An electrical change in the light-emitting layer either causes an optical response across a corresponding sub-pixel of the display or, by electrical connection, causes an optical response across the entire pixel. In this manner a large display such as a wallboard or a billboard can be realized. The billboard is addressed via matrix addressing, as well by a laser projector that rasterizes across the rear or by a slide projector that projects onto the display.

WO-2004/090624 A1 discloses a display for displaying and storing images and comprises an optically addressable electrophoretic display with a stack of a photoconductive layer and an electrophoretic layer being sandwiched between electrodes. An optical addressing circuit supplies addressing light to the photoconductive layer. A controller controls a driver to supply a drive voltage between the electrodes with a value enabling a change of the optical state of the electrophoretic layer in response to the addressing light impinging on the photoconductive layer. Then, the driver changes the drive voltage to a value enabling storage of the optical state of the electrophoretic layer independent on the amount of addressing light impinging on the photoconductive layer. Finally, the power consumption of the optical addressing means is minimized and the image displayed by the electrophoretic layer is kept without requiring a voltage over the electrophoretic layer.

An important characteristic of electrophoretic displays is that once an image is written into its pixels, this image can be retained for a long period of time without requiring any drive pulses.

As both the photoconductive layer and the electrophoretic layer have a capacitance, the voltage applied to the electrodes will be capacitively tapped during level changes. Therefore, when the display is activated, this voltage has to be increased sufficiently slowly, such that the voltage across the electrophoretic layer stays low enough. If the voltage rises too steep, due to the capacitive division, the voltage across the electrophoretic layer may become too large and influence its behavior. After the voltage has been applied sufficiently slowly, the writing of the data with the addressing light can start. After the writing operation, the voltage should slowly decrease, again to prevent undesired voltages across the electrophoretic layer which may change the optical state of the electrophoretic layer. These slow changes of the voltage have the drawback that it takes a relatively long time to refresh the image on the display.

It is an object of the invention to provide a rollable bi-stable display which requires less time to present a next image.

To achieve this object, a first aspect of the invention provides a system comprising a rollable sheet forming a loop as claimed in claim 1. A second object of the invention provides a billboard as claimed in claim 11. A third object of the invention provides the use of a rollable sheet forming a loop in a billboard. A fourth object of the invention provides a method of displaying an image in a system comprising the rollable sheet as claimed in claim 13. Advantageous embodiments are defined in the dependent claims.

The system in accordance with the first aspect of the invention comprises a rollable sheet which forms a loop. Preferably, two spindles are present for rollably supporting the loop of the rollable sheet. The rollable sheet has a first section forming a first optically addressable bi-stable display and a second section forming a second optically addressable bi-stable display. The second section is electrically isolated from the first section such that voltages applied to the first and the second section may differ. A rotating unit, for example by a motor coupled to one of the spindles, rotates the sheet between a first and a second position. In the first position, the first section is viewable while the second section is hidden to the viewer. And in the second position, the second section is viewable while the first section is hidden. Thus, if the second section is visible by a viewer, the first section is hidden behind the second section and thus invisible.

A changing unit is present to change, in the second position, the image on the first section while an image on the second section is displayed to the viewer. After the image has been changed on the first section, the rollable sheet is rotated such that the first section is presented to the viewer and the second section is hidden to the viewer. Now, the image on the second section can be changed while the image on the first section is presented to the viewer.

In contrast to the prior art which uses a single stationary display, in the present invention the new image is written on one of the sections while the other section is presented to the viewer. Consequently, the viewer is not confronted with a long time wherein the viewable image on the display is changing.

In an embodiment in accordance with the invention, the changing of the image which is not visible is performed with a changing unit which comprises a first voltage generator, a second voltage generator, an addressing unit, and a controller. The controller controls, in the following sequence:

(i) the first voltage generator to supply a first voltage waveform to the first section when the first section is in the second position. The first voltage waveform has a first portion for erasing a previous image on the first section, and a second portion for applying an addressing voltage level across the first section allowing the first section to be optically addressed,

(ii) the rotating unit to rotate the sheet from the first position to the second position, and the addressing unit to locally address the first section while the sheet is being rotated to obtain the first image on the first section, and

(iii) a second voltage generator to supply a second voltage waveform to the first section when in the second position, the second voltage waveform changing the addressing voltage level to a holding level wherein the first image on the first section is hold.

Thus, first the image on the first section is erased such that all pixels have the same optical state. After the erasing, the voltage across the first section is changed to a level at which the first section is addressable. The addressing unit writes the next image to the display by moving the addressing unit and the display with respect to each other. Preferably, the addressing unit does not cover the complete first section, therefore, at a particular instant, only the part of the display which is associated with the addressing unit is addressed. Thus, the portion of the display which did not yet pass the addressing unit is not yet addressed by the addressing unit to display the new image. The already addressed portion of the display will keep the information earlier written by the addressing unit because of the bi-stable character of the display, but only if no light impinges on this part. The complete display will be addressed as it passes the addressing unit during the rotation of the first section. Thus the display is completely addressed and displays the new picture when it has completely passed the addressing unit. The length of the display (defined as the amount of display which has to pass the addressing unit) does not influence the complexity of the display and of the addressing unit.

After the first section has been addressed completely, the second voltage generator now takes over the role of the first voltage generator and changes the voltage across the first section towards a hold level which allows the first section to hold the new image even when light is impinging on the first section. Now, the image can be presented to the viewer by switching on the backlighting (in a transmissive display) or allowing ambient light to impinge on the first section (in a reflective display).

In an embodiment in accordance with the invention, the first section and the second section comprise a stack of layers in the order: a first electrode layer, an electrophoretic layer or a cholesteric texture liquid crystal layer, a photoconductor layer, and a second electrode layer. The electrophoretic layer has a first capacitance, and the photoconductor layer has a second capacitance. Such a stack is known from WO-2004/090624 A1. During the first portion of the first voltage waveform, the first voltage generator, which is coupled between the first electrode layer and the second electrode layer, supplies a series of pulses having alternately an opposite polarity. The second capacitance is larger than the first capacitance such that the first voltage waveform is predominantly present across the electrophoretic layer, more or less independent of the resistances of the electrophoretic layer and the photoconductor layer.

In an embodiment in accordance with the invention, during the second portion, the first voltage generator changes the positive or negative level of the first voltage waveform at the end of the first portion to an address voltage level. Thus, at the end of the second portion, the electrophoretic layer has a defined optical state, and the optical state of the electrophoretic layer can be changed by light impinging on the photoconductor layer. A speed of changing of the first voltage waveform is selected to obtain a voltage division over the electrophoretic layer and the photoconductive layer which is predominantly determined by a respective resistance of these layers and not by the first and the second capacitance. Thus, during the second portion, the first voltage waveform changes its level sufficiently slowly such that the optical state of the electrophoretic layer as obtained by the erasing is substantially kept.

In an embodiment in accordance with the invention, the second voltage generator changes the addressing voltage level supplied by the first voltage waveform at the end of the second portion to a holding voltage level at which an optical state of the electrophoretic layer reached after the addressing means has addressed the first section is kept, independent on an amount of light impinging on the photoconductor layer. A speed of changing of the second voltage waveform is selected to obtain a voltage division over the electrophoretic layer and the photoconductive layer which is predominantly determined by a respective resistance of these layers and not by the first and the second capacitance. Thus, the second voltage waveform changes its level sufficiently slowly such that the optical state of the electrophoretic layer as obtained by the addressing is substantially kept.

In an embodiment in accordance with the invention, after the first section has been erased and the first voltage generator has changed the voltage across the first section to the addressing voltage level, the photoconductive layer is selectively illuminated. At the positions where the photoconductor is illuminated, the resistance of the photoconductor is much lower than that of the electrophoretic layer and the addressing voltage level is predominantly present across the electrophoretic layer to change the optical state thereof. At locations where the photoconductor is not illuminated, its resistance is much higher than that of the electrophoretic layer and the addressing voltage level is predominantly present over the photoconductor. Now, the optical state of the electrophoretic layer is not or almost not influenced. The next image can be written on the first section during the movement of the first section from the second to the first position.

Preferably, the series resistance formed by the resistances of the photoconductive layer and the electrophoretic layer is high such that large RC-times are created. The large RC-times cause an induced charge in response to the light pulses applied to the photoconductive layer. It takes some time before the charge leaks away. The time that the charge is present determines the change of the optical state of the electrophoretic layer. Consequently, a light pulse with a duration shorter than the time required by the electrophoretic layer to change its optical state suffices to address the pixels. The charge introduced by this light pulse is present sufficiently long. In an practical embodiment, a duration of the light pulse in a range of 0.1 to 1 ms was sufficient.

In an embodiment in accordance with the invention, the controller activates the light source during a period in time wherein the rotating unit rotates the first section from the second position to the first position. The first voltage generator is disconnected from the first section after the first section has been addressed, and the second voltage generator is connected to the first section after the first voltage generator has been disconnected from the first section.

Preferably, the first voltage generator is stationary positioned and is connected to the first portion as long as the first section is in the second position until during the rotation of the sheet until the end of the first section has passed the first voltage generator. The second voltage generator is stationary positioned and is connected to the first portion as soon as the start of the first section is at the position of the second voltage generator. The second voltage generator should be positioned such that it is connected to the first section if in the first position. The second voltage generator may be disconnected from the first section if in the first position after the addressing voltage level has been changed into the holding voltage level.

In an embodiment in accordance with the invention, the light source comprises a scanning laser, or a line of light emitting diodes such as PLED's. This has the advantage that only a single laser, or only a line of diodes is required.

The line of diodes extends substantially perpendicular with respect to the direction of movement of the display. The number of light sources in the line determines the resolution of the display. When the display is at a position along the direction of movement with respect to the addressing unit where a line of data has to be provided to obtain a corresponding line of pixels on the display, the addressing unit controls the light sources of the line to produce light in accordance with an image to be displayed at this position. At a next position along the direction of movement of the display the addressing unit controls the light sources to produce light in accordance with the image to be displayed at this next position. In this manner, the image is written on the display line by line while the display is being moved with respect to the addressing unit. The addressing unit may comprise several lines of light sources to address several lines of pixels of the display at the same time to increase the writing speed.

The laser may scan a single line and the addressing of a complete section of the bi-stable display is possible because the display moves along the scanning laser beam or the stationary positioned line of diodes. The laser may also scan along the complete section when this section is kept in the hidden position. It is possible that the line of light emitting diodes is moving along part of or the complete section during the period in time the section is resting in the hidden position. It is not essential that the diodes form a complete line, the diodes may also move in a direction perpendicular to the direction of movement of the section when moved from the hidden (second) position to the viewable (first) position.

Thus, the addressing unit can be simple because it only needs to address the display locally. The addressing unit is not dependent on the length of the display. The length of the display is defined as the dimension of the display in the direction of the rolling movement. The dimension of the display perpendicular to the direction of rolling is referred to as the width. It is possible that the width is larger than the length of the display. Such an addressing unit is especially advantageous if very large display areas are used such as in billboards.

The use of an addressing unit which directs light towards the display has the advantage that the display is addressable without making contact with the display. The display can be rotationally moved without wearing its surface by the addressing device.

The movement of the display and the addressing of the addressing device have to be synchronized to write the information into the correct position of the display. Possible ways of synchronizing have been discussed in WO-2004/090624 A1.

In an embodiment in accordance with the invention, the electrophoretic displays comprise oppositely charged particles having a different optical property, such as for example, E-ink displays. Such, displays may be monochrome displays or (full) color displays. Only the two limit optical states, which usually are black and white, may be used, or also grayscales may be made. The color displays may have differently colored particles intermingled in the same cell, or may have different cells for different colors.

These and other aspects of the invention are apparent from and will be elucidated with reference to the embodiments described hereinafter.

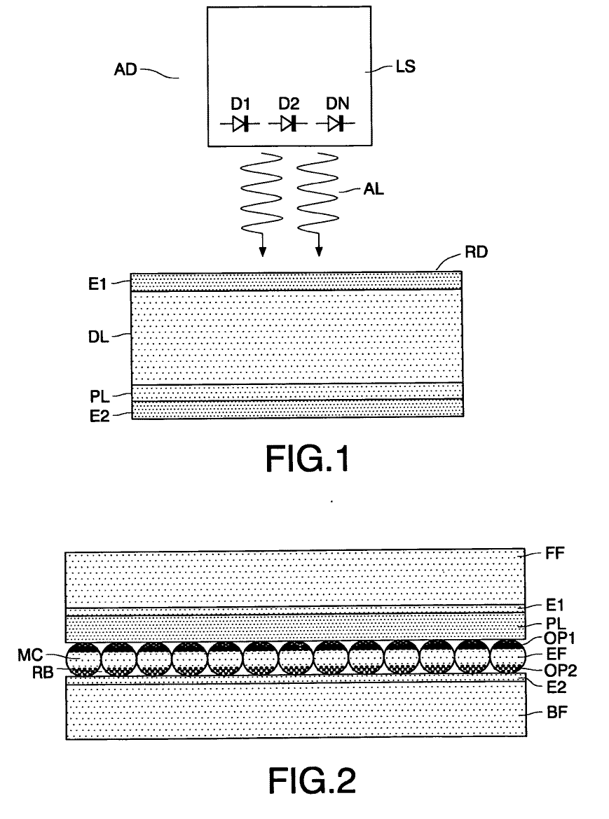

FIG. 1 shows an optically addressed rollable bi-stable display,

FIG. 2 shows an optically addressable electrophoretic display,

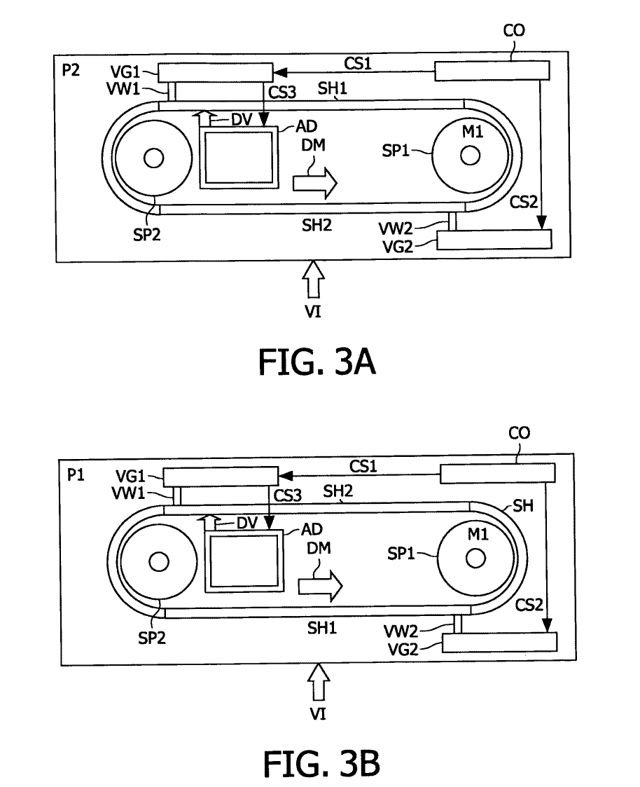

FIGS. 3A-3B show schematically an embodiment of system in accordance with the invention comprising a rollable sheet arranged in a loop, and having a first section forming a first optically addressable bi-stable display and a second section forming a second optically addressable bi-stable display, both in a first and a second position,

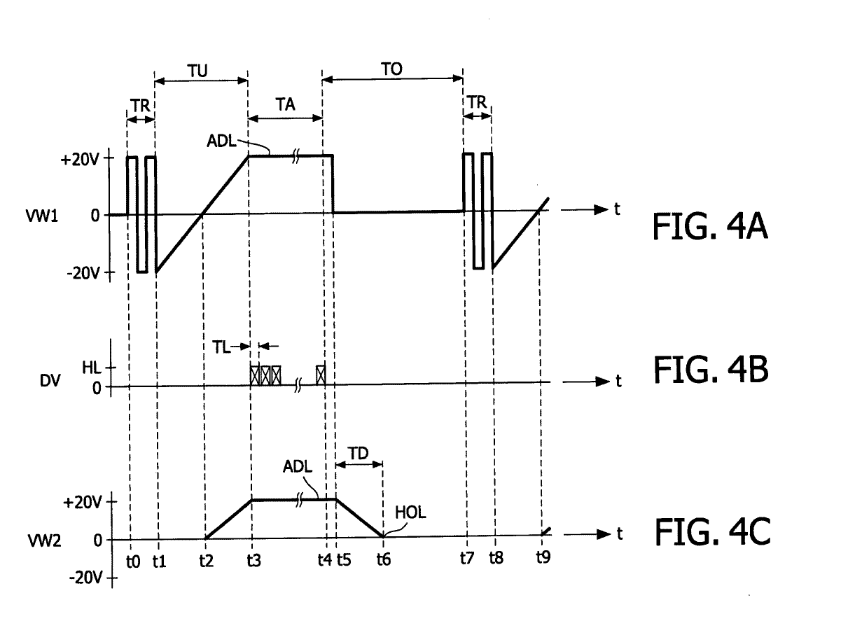

FIGS. 4A-4C show waveforms for elucidating the system shown in FIG. 3, and

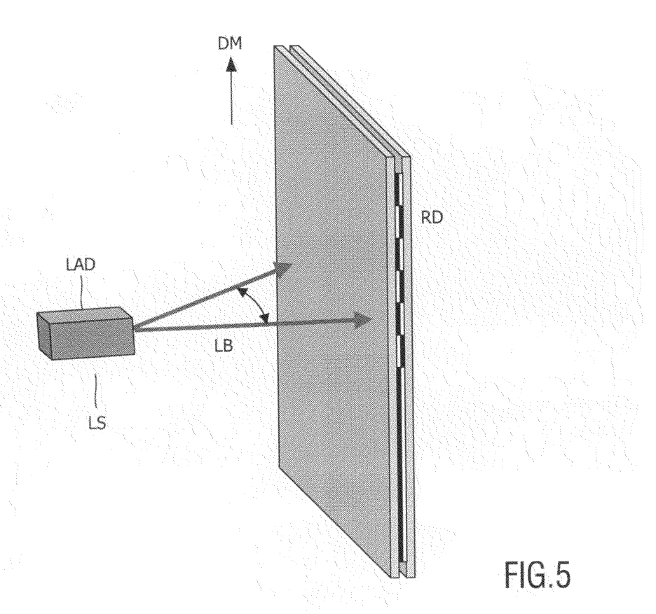

FIG. 5 shows an addressing unit comprising a scanning laser.

The same references in different Figures refer to the same entities.

FIG. 1 shows an optically addressed rollable bi-stable display. In this embodiment in accordance with the invention, the addressing device AD comprises a light source LS which generates light AL. The bi-stable display RD comprises a stack of layers, which seen from the light source LS occur in the order: a top electrode E1, a display substance DL, a photoconductive layer PL, and a bottom electrode E2. Alternatively, the photoconductive layer PL may be sandwiched between the top electrode E1 and the display substance DL.

Preferably, the top electrode E1 is a transparent conductive ITO layer. The display substance DL may be any substance suitable to be operated as a bi-stable display. A bi-stable display is a display of which the optical state does not change when no voltage is applied across it. Examples of bi-stable displays are electrophoretic displays and cholesteric texture LCD's. The photoconductive layer PL comprises a material of which the resistance at a particular location depends on an amount of light impinging at this particular location. The bottom electrode is a conductive layer, which preferably is a metal or ITO layer.

In a mode of the display RD wherein it is sensitive to the light AL, a voltage is supplied between the top electrode E1 and the bottom electrode E2. If the light AL impinges at a particular location on the photoconductive layer PL, its conductivity locally increases. At this particular location, a major part of the voltage supplied between the top and the bottom conductive layers E1 and E2 will be present across the display substance DL and will influence its optical state. If no light impinges on the photoconductive layer PL, its resistance is very high which respect to the resistance of the display substance DL. The voltage between the top electrode E1 and the bottom electrode E2 will occur substantially across the photoconductive layer PL and substantially no voltage will occur across the display substance DL, the optical state of the display substance DL does not change.

It is thus possible to selectively change the optical state of the display substance DL with a simple addressing device AD which preferably comprises a light source LS which comprises a line or a matrix of light sources D1 to DN. The set of light sources D1 to DN is driven to address a corresponding set of pixels on the display RD. The addressing device AD needs to address a small area of the display RD only. The complete display RD will be addressed because it moves along the addressing device AD. Preferably, the addressing device AD addresses a line of pixels at a time. The line of pixels extends substantially perpendicular to the direction DM of movement of the display RD and over the complete width of the display RD. This allows addressing the display RD line by line while it moves along the addressing device AD. If the addressing device AD does not cover the complete width of the display RD, the addressing device AD may be moved in the direction substantially perpendicular to the direction DM, for example, as is known from printer heads.

If the addressing device AD is allowed to move, the resolution of the pixels P is not longer limited by the spacing of the light sources LS of the addressing device AD. For example, if the complete display RD moves along the addressing device AD two times at slightly shifted positions of the addressing device AD, the resolution is twice as high. Preferably, the first and the second position are shifted in the direction of the rolling of the display such that the positions with respect to the display interleave.

Alternatively, the light source LS may comprise a scanning laser LAD as shown in FIG. 5.

The construction of the display RD is very simple, no matrix display is required, the top electrode E1 and the bottom electrode E2 may cover the complete top and bottom of the display, respectively. It is not required to use segmented intersecting electrodes and active elements to be able to address the pixels individually. However, this is not relevant to the invention; the shorter address time can also be reached in displays which have a pixilated structure. For example, floating conductive pads may be arranged between the photoconductor and the electrophoretic material to improve the accuracy of the grey level.

FIG. 2 shows an optically addressable electrophoretic display. This embodiment of the optically addressable electrophoretic display comprises a stack of the next consecutive layers: a back foil BF, a back electrode E2, an electrophoretic layer EF, a photoconductive foil PL, a front electrode E1, and a front foil FF. Other optically addressable electrophoretic displays are possible. In the embodiment of the electrophoretic display shown, the electrophoretic layer EF comprises microcapsules MC and a binder RB in-between the microcapsules MC. Such an electrophoretic display is also referred to as E-ink (electronic ink) display, and the electrophoretic layer EF is also referred to as E-ink layer. The microcapsules MC are filled with colored particles OP1 and OP2. In the display shown, each microcapsule MC comprises white and black particles OP1 and OP2 which are oppositely charged. The particles OP1 and OP2 are moved in the microcapsules MC by supplying a voltage and thus an electric field across the microcapsules MC.

The voltage supplied between the front electrode E1 and the back electrode E2 occurs across the series arrangement of the photoconductive foil PL and the electronic ink layer EF. If light impinges at a particular location on the photoconductive foil PL, the conductivity of the photoconductive foil PL increases. At this particular location, a major part of the voltage supplied between the electrodes E1 and E2 will be present across the electrophoretic layer EF. The electrical field caused by the voltage across the electrophoretic layer moves the charged particles OP1 and OP2 and thus influences the optical state of the microcapsule(s) at this location.

Besides the E-ink display, many other types of electrophoretic displays exist. For example, in an electrophoretic display of the company SiPix only positively charged particles may be present in a colored liquid. Or, in an electrophoretic display of the company Bridgestone, the two different particles are present in an air-system. Also in-plane switching is possible: the particles are moved in-plane between two electrodes of different areas. The large electrode is transparent and a backlight is present. The backlight is switched on if the ambient light is insufficient to operate the display in the reflective mode.

As both the photoconductive foil PL and the electrophoretic layer EF have a capacitance, the voltage applied to the electrodes E1 and E2 will be capacitively tapped during the level changes. Therefore, when the display is activated, this voltage has to be increased sufficiently slowly, such that the voltage across the electrophoretic layer EF stays low enough. If the voltage rises too steeply, the voltage across the electrophoretic layer EF may become too large due to the capacitive division, and may influence the optical state of the electrophoretic layer EF. After the voltage has been applied sufficiently slowly, the writing of the data with the addressing light can start. After the writing operation, the voltage should slowly decrease, again to prevent undesired voltages across the electrophoretic layer EF which may influence the optical state of the electrophoretic layer EF.

It is possible to use this capacitive division to erase the display. If a sufficiently high voltage is applied sufficiently fast, the electrophoretic layer EF will change into one of its optical limit situations: for example, it will become completely black or white if black and white particles are used. This allows bringing the display RD in a well defined initial state before the addressing device AD writes the information to the display RD when it is moved which respect to the addressing device AD.

Further, the capacitance of the electrophoretic layer EF has the drawback that a voltage across the electrophoretic layer EF will leak away only slowly. Thus after removing the voltage across the electrodes E1 and E2, still a voltage will be present across the microcapsules MC causing the optical state of the microcapsule to further change.

As an example only, in a practical embodiment, the electrophoretic layer EF is an E-ink layer with a thickness of 50 μm. The thickness of the photoconductor layer PL is a factor 10 less than the thickness of the E-ink layer. The resistance area product of the photoconductor is 10 MΩm² in the dark state and 10 kΩm² in the illuminated state. The resistance area product of the E-ink is 200 kΩm². More in general, preferably, the capacitance of the E-ink is substantially lower than that of the photoconductor, the resistance of both the E-ink and the photoconductor is very high to obtain large time constants, and the resistance of the photoconductor should be higher that that of the E-ink when not illuminated and lower when illuminated.

FIGS. 3A-3B show schematically an embodiment of system in accordance with the invention comprising a rollable sheet arranged in a loop, and having a first section forming a first optically addressable bi-stable display and a second section forming a second optically addressable bi-stable display, both in a first and a second position.

Both FIG. 3A and FIG. 3B show a rollable sheet SH which is arranged in loop around a first spindle SP1 and a second spindle SP2. The rollable sheet SH has a first section SH1 which is a first optically addressable bi-stable display and a second section SH2 which is a second optically addressable bi-stable display. The electrode layers of the first section SH1 and the second section SH2 are electrically isolated.

A motor M1 drives the first spindle to rotate said sheet SH in a loop. FIG. 3B shows a first position P1 of the sheet SH wherein the first section SH1 is viewable by a viewer VI while the second section SH2 is hidden to the viewer VI. FIG. 3A shows a second position P2 of the sheet SH wherein the second section SH2 is viewable by the viewer VI while the first section SH1 is hidden to the viewer. The section which is visible to the viewer VI is also referred to as the visible section. This visible section may be either the first or the second section SH1, SH2 dependent on the position of the sheet SH. The section which is invisible to the viewer VI is also referred to as the update section. This update section may be either the first or the second section SH1, SH2, dependent on the position of the sheet SH.

The system further comprises a voltage generator VG1, a voltage generator VG2, an addressing unit AD, and a controller CO. The controller CO supplies control signals CS1, CS2, CS3 to the voltage generator VG1, the voltage generator VG2 and the addressing unit AD, respectively.

FIGS. 4A-4C show waveforms for elucidating the system shown in FIG. 3. FIG. 4A shows the voltage waveform VW1 supplied by the voltage generator VG1, FIG. 4B shows the data voltage DV supplied by the addressing unit AD, and FIG. 4C shows the voltage waveform VW2 supplied by the voltage generator VG2.

It is assumed that at the instant to, the sheet SH is in the second position P2 as shown in FIG. 3A. The voltage generator VG1 supplies the voltage waveform VW1 to the first section SH1. In the first position, the first section SH1 is also referred to as the update section because the image is updated on this section which is invisible to the viewer VI, and the second section SH2 is also referred to as the visible section SH2.

The voltage waveform VW1 has a first portion TR which lasts from the instant t0 to the instant t1 and which comprises pulses with opposite polarity to erase a previous image on the update section SH1. It is not required to flood the update section SH1 with light to be able to erase this section. The voltage waveform VW1 has a second portion TU which lasts from the instant t1 to the instant t3 and which slowly changes the level at the end t1 of the first portion TR to an addressing voltage level ADL allowing the update section SH1 to be optically addressed with the addressing unit AD. This addressing voltage level ADL must have the opposite polarity with respect to the polarity of the last reset level. The last reset level changes the display to one of the limit optical states. During the addressing phase, it should be possible to change the optical state of the pixels towards the other limit optical state. Preferably, in an E-ink display with negatively charged white and positively charged black particles, the erase pulse ends with a negative voltage such that the display is black. Now, the addressing voltage level ADL should be positive to allow the selected pixels to change their optical state towards white during the addressing phase. The change from the level of the last reset pulse to the addressing level must be slow enough to avoid a too large voltage drop over the electrophoretic layer DL due to the capacitive coupling of the capacitance of the electrophoretic layer DL and the photoconductor PL. For example only, in a practical embodiment it is found that the gradient of the voltage change must not be larger than 0.75V/s for the layer thicknesses and resistance area products mentioned hereinbefore. Thus, for a swing of 30V, the total ramp time is 40 s. In the prior art approach this would mean that a pause of 40 s would be present during which a blank (one of the limit optical states) image is presented to the viewer VI. In accordance with the present invention, no useful image is presented to the viewer only during the much shorter time the sheet SH is rotated such that the update section is rotated from the update position to the visible position. The erasing of the update section is performed during the time the visible section is presented to the viewer. As the image is written during the rotation of the update section from the update position to the visible position, the viewer is immediately presented with a picture which moves from the start of the visible area to the end thereof.

At the instant t3 when the voltage waveform VW1 has the addressing voltage level ADL, the motor M1 starts rotating the sheet SH in the direction indicated by the arrow DM, and the addressing unit AD locally addresses the update section SH1 while it moves along the addressing unit AD. When, at the instant t4, the complete update section SH1 has been addressed, a new image has been written on the update section SH1. The time required to address the complete update section SH1 is referred to as the update period TA. At the instant t4 the voltage generator VG1 is disconnected from the update section SH1. During the update period TA, the addressing unit DA optically addresses a single or a group of pixels. A pixel which should keep its optical state obtained after the erasing period TR must not be illuminated. A pixel which should change its optical state obtained after the erasing period should be illuminated. It has to be noted that the bi-stable displays itself do not necessarily have a pixel structure. The dimensions of the impinging light spots determine the pixel areas. If the optical addressing is performed by a light source LS which comprises a line of light sources D1 to DN, the update section can be addressed line by line. The pixels of each line are addressed in parallel during a line period TL.

It is assumed that at the instant t5, when the sheet is rotated to the position P1 shown in FIG. 3B, the update section SH1 is moved to the visible position and in the following is referred to as the visible section SH1. At the instant t5 the voltage generator VG2 should be connected to the visible section SH1 and should supply the voltage waveform VW2 with the addressing voltage level ADL. This addressing voltage level ADL is slowly changed to the holding level HOL during the period in time TD which lasts from the instant t5 to the instant t6. The holding level HOL is a level which allows the image on the visible section SH1 to be held independent on light impinging on the visible section SH1.

The level of the voltage waveform VW2 outside the period TD is not relevant because the voltage generator VG2 is or may be disconnected from the section which is showing the image which should be held. Preferably, as shown in FIG. 4C, the voltage generator VG1 and the voltage generator VG2 are connected and disconnected to the same main generator (not shown). This main generator supply the erase pulses during the erase periods TR, the ramping voltage during the period TU, the addressing level during the addressing period TA, and the ramping down voltage during the period TD. The voltage generator VG1 is connected to the main voltage generator during the periods TR, TU, and TA and is disconnected during the period TO which starts at the instant t4 or the instant t5 and lasts to the instant t7 at which a next cycle starts with a next period TR. The voltage generator VG2 may be connected to the main voltage generator during the period in time lasting from the instant t2 to the instant t6, but must at least be connected during the period TD.

At the instant t7 the next cycle starts, now the section SH2 is in the invisible position and is called the update section SH2, and the section SH1 is in the visible position. During the erase period TR, which lasts from the instant t7 to the instant t8, the image on the update section SH2 is erased. At the instant t8, the period TU starts again and the voltage waveform VW1, now supplied to the update section SH2, starts up-ramping. In fact, the same sequence as elucidated hereinbefore is repeated, but now the update section is the section SH2 instead of the section SH1.

FIG. 5 shows an addressing unit comprising a scanning laser. The laser scanner LAD scans a laser beam LB along the optically addressable electrophoretic display RD. The intensity of the laser beam LB is controlled in accordance with the image to be written on the photoconductive layer PL. The operation of the laser addressed electrophoretic display RD is similar to the operation of the optically addressed electrophoretic display RD which is addressed by a line of light sources D1 to DN. First the electrophoretic display RD is brought in a state wherein the local conductivity of the photoconductive layer PL determines the optical state of the electrophoretic layer DL. Then, the laser scanner LAD is activated to scan the laser along the electrophoretic display RD to transfer the image to the photoconductive layer PL and thus to the electrophoretic layer DL. Now, the electrophoretic display RD is brought in a state wherein the optical state of the electrophoretic layer DL is stored independent on the local conductivity of the photoconductive layer PL. Preferably, the laser scanner LAD scans the laser beam LB across a line while the electrophoretic display RD is moved in the direction perpendicular to this line. In FIG. 5, the electrophoretic display RD moves in accordance with the arrow DM which indicates the direction of movement.

It should be noted that if it is referred to pixels of or on the display RD, it is not meant that hardware cells must be present in the display RD. The display RD may have a homogeneous construction. Then, the pixels P are only referred to as areas of the display RD which are present due to the addressing of the display RD with the discrete light sources LS, pointed electrodes AD1 or mechanical sliders MS of the addressing device AD.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system comprising
a rollable sheet (SH) forming a loop, and having a first section (SH1) forming a first optically addressable bi-stable display and a second section (SH2) forming a second optically addressable bi-stable display, the first section (SH1) and the second section (SH2) being electrically isolated,
rotating means for rotating (SP1, SP2, M1) said sheet (SH), wherein in a first position (P1), the first section (SH1) is viewable while the second section (SH2) is hidden, and in a second position (P2), the second section (SH2) is viewable while the first section (SH1) is hidden, and
means for changing (VG1, VG2, AD, CO) a first image on the first section (SH1) while displaying a second image on the second section (SH2) when in the second position (P2), and for changing the second image of the second section (SH2) while displaying the first image on the first section (SH1) when in the first position (P1).

2. A system as claimed in claim 1, wherein the means for changing (VG1, VG2, AD, CO) comprises a first voltage generator (VG1), a second voltage generator (VG2), an addressing means (AD), and a controller (CO) for controlling, in the following sequence:
(i) the first voltage generator (VG1) to supply a first voltage waveform (VW1) to the first section (SH1) when the first section (SH1) is in the second position (P2), the first voltage waveform (VW1) having a first portion (TR) for erasing a previous image on the first section (SH1), and a second portion (TU) for applying an addressing voltage level (ADL) across the first section (SH1) allowing the first section (SH1) to be optically addressed,
(ii) the rotating means (SP1, SP2, M1) to rotate said sheet (SH) from the second position (P2) to the first position (P1), and the addressing means (AD) to locally address the first section (SH1) while said sheet (SH) is being rotated, to obtain the first image on the first section (SH1), and
(iii) the second voltage generator (VG2) to supply a second voltage waveform (VW2) to the first section (SH1) when in the first position (P1), the second voltage waveform (VW2) changing the addressing voltage level (ADL) to a holding level (HOL) wherein the first image on the first section (SH1) is held.

3. A system as claimed in claim 2, wherein the first section (SH1) and the second section (SH2) comprise a stack comprising in the order mentioned: a first electrode layer (E1), an electrophoretic layer or an cholesteric texture liquid crystal layer (DL) having a first capacitance, a photoconductor layer (PL) having a second capacitance, and a second electrode layer (E2), wherein the first voltage generator (VG1) is coupled between the first electrode layer (E1) and the second electrode layer (E2), and is arranged for supplying a series of pulses having alternately an opposite polarity during the first portion (TR) of the first voltage waveform (VW1), and wherein the second capacitance is larger than the first capacitance to obtain, during the first portion (TR), the first voltage waveform (VW1) being predominantly present across the electrophoretic layer or the cholesteric texture liquid crystal layer (DL).

4. A system as claimed in claim 3, wherein the first voltage generator (VG1) is arranged for, during the second portion (TU), changing the positive or negative level of the first voltage waveform (VW1) at the end of the first portion (TR) to the address voltage level (ADL) at an end (t3) of the second portion (TU) at which a defined optical state of the electrophoretic layer (DL) is obtained, and at which an optical state of the electrophoretic layer (DL) depends on an amount of light impinging on the photoconductor layer (PL), a speed of changing of the first voltage waveform (VW1) being selected to obtain a voltage division over the electrophoretic layer (DL) and the photoconductive layer (PL), the voltage division being predominantly determined by a respective resistance of these layers (DL, PL) and not by the first and the second capacitance.

5. A system as claimed in claim 3, wherein the second voltage generator (VG2) is arranged for changing the address voltage level (ADL) of the first voltage waveform (VW1) at the end (t3) of the second portion (TU) to a holding voltage level (HOL) at which an optical state reached after the addressing means (AD) has addressed the first section (SH1) of the electrophoretic layer (DL) is kept, independent on an amount of light (AL) impinging on the photoconductor layer (PL), a speed of changing of the second voltage waveform (VW2) being selected to obtain a voltage division over the electrophoretic layer (DL) and the photoconductive layer (PL) which is predominantly determined by a respective resistance of these layers (DL, PL) and not by the first and the second capacitance.

6. A system as claimed in claim 2, wherein the addressing means (AD) comprises at least one light source (LS) for selectively illuminating the photoconductive layer (PL) after the end (t3) of the second portion (TU) of the first voltage waveform (VW1).

7. A system as claimed in claim 6, wherein the controller (CO) is arranged for
selectively activating the at least one light source (LS) during a period in time (TA) wherein the rotating means (SP1, SP2, M1) is controlled for rotating the first section (SH1) from the second position (P2) to the first position (P1),
disconnecting the first voltage generator (VG1) from the first section (SH1) after the first section (SH1) has been addressed, and
connecting the second voltage generator (VG2) to the first section (SH1) after the first voltage generator (VG1) has been disconnected from the first section (SH1).

8. A system as claimed in claim 6, wherein the at least one light source (LS) comprises a scanning laser (LAD), or a line of light emitting diodes (D1 to DN) extending substantially perpendicular with respect to a direction of movement of said sheet (SH).

9. A system as claimed in claim 2, wherein the rotating means (SP1, SP2, M1) comprise a first and a second spindle (SP1, SP2) for holding the rollable sheet (SH) in the loop, and a motor (M1) being coupled to the first spindle (SP1) to rotate the first spindle (SP1).

10. A system as claimed in claim 1, wherein the first section (SH1) and the second section (SH2) comprises oppositely charged particles (OP1, OP2) having at least one different optical property.

11. A billboard comprising the system as claimed in claim 1.

12. Use of a rollable sheet (SH) forming a loop in a billboard, the rollable sheet (SH) having a first section (SH1) forming a first optically addressable bi-stable display and a second section (SH2) forming a second optically addressable bi-stable display, the first section (SH1) being electrically isolated from the second section (SH2).

13. A method of displaying an image in a system comprising a rollable sheet (SH) forming a loop, and having a first section (SH1) forming a first optically addressable bi-stable display and a second section (SH2) forming a second optically addressable bi-stable display, the first section (SH1) and the second section (SH2) being electrically isolated, the method comprising
rotating (SP1, SP2, M1) said sheet (SH), wherein in a first position (P1), the first section (SH1) is viewable while the second section (SH2) is hidden, and in a second position (P2), the second section (SH2) is viewable while the first section (SH1) is hidden, and
changing (VG1, VG2, AD, CO) a first image on the first section (SH1) while displaying a second image on the second section (SH2) when in the second position (P2), and for changing the second image of the second section (SH2) and for displaying the first image on the first section (SH1) when in the first position (P1).

14. A method as claimed in claim 13, wherein the changing comprises, in the following sequence:
(i) supplying (VG1) a first voltage waveform (VW1) to the first section (SH1) when the first section (SH1) is in the second position (P2), the first voltage waveform (VW1) having a first portion (TR) for erasing a previous image on the first section (SH1), and a second portion (TU) for applying an addressing voltage level (ADL) across the first section (SH1) allowing the first section (SH1) to be optically addressed,
(ii) rotating (SP1, SP2, M1) said sheet (SH) from the second position (P2) to the first position (P1), and the addressing means (AD) to locally address the first section (SH1) while said sheet (S1) is being rotated, to obtain the first image on the first section (SH1), and
(iii) supplying (VG2) a second voltage waveform (VW2) to the first section (SH1) when in the first position (P1), the second voltage waveform (VW2) changing the addressing voltage level (ADL) to a holding level (HOL) wherein the first image on the first section (SH1) is hold.

15. A method as claimed in claim 14, wherein the optically addressing (AD) comprises
generating (LS) at least one light beam (AL) for selectively illuminating the photoconductive layer (DL) after the end (t3) of the second portion (TU) of the first voltage waveform (VW2) and during a period in time (TA) the rotating (SP1, SP2, M1) is moving the first section (SH1) from the second position (P2) to the first position (P1), and
disconnecting (CO) the supplying (VG1) of the first voltage waveform (VW1) from the first section (SH1) after the first section (SH1) has been addressed, and
connecting (CO) the supplying (VG2) of the second voltage waveform (VW2) to the first section (SH1) after the disconnecting (CO) of the first voltage waveform (VW1) from the first section (SH1).
